(19) United States
(12) Patent Application Publication
(10) Pub. No.: US 2005/0190071 A1
(43) Pub. Date: Sep. 1, 2005

(54) [ADAPTOR HAVING VIDEO/AUDIO PLAYER FUNCTIONALITY]

(75) Inventors: Chien-An Chen, Chutung Town, Hsinchu Hsien (TW); Chien-Chen Liou, Chutung Town, Hsinchu Hsien (TW)

Correspondence Address: PHISON ELECTRONICS CORPORATION, 2F-4. NO. 148, SEC. 4, CHUNG HSIAO EAST ROAD, TAIPEI, TW

(73) Assignee: PHISON ELECTRONICS CORP., Chutung Town, Hsinchu Hsien. (TW)

(21) Appl. No.: 10/708,350

(22) Filed: Feb. 26, 2004

(51) Int. Cl. H04L 17/02; G05B 19/02; G08C 19/12

(52) U.S. Cl. 340/825.24

(57) ABSTRACT

An adaptor having video/audio player functionality is disclosed. The adaptor has a data storage device, without video/audio player functionality and an encoder/decoder device, for encoding/decoding the video/audio data, the encoder/decoder device is connected to an USB port adapted for connecting to the data storage device, wherein the encoder/decoder device decodes the video/audio data stored in the data storage device so that the decoded video/audio data can be played via video/audio device connected to the encoder/decoder device via the USB port.

### BACKGROUND OF INVENTION

1. The Field of the Invention

The present invention generally relates to an adaptor adapted for connecting to a data storage device, and more particularly to an adaptor having video/audio player functionality.

2. Description of Related Art

The advantageous features, such as, low power consumption, non-volatile, shock proof, high storage density and so on, have made the flash memory to gradually replace the EEPROM or the portable device providing power using battery. And with the rapid development in semiconductor technology, it is presently possible to manufacture a flash memory with higher storage capacity and higher transmission speed, and therefore the flash memory advantageously replaced the conventional storage media, such as hard disk. This trend further led to the development of a portable disk and a memory card, which are presently very popular and essential product. Accordingly, further improvement of the portable disk has become a major topic in the field. It is highly desirable to develop a portable disk or a memory card to achieve, for example, besides storing data, also video/audio player functionality.

However, when a user desires to run a multimedia function using a portable disk or a memory card without the multimedia functionality, the user needs to purchase a new portable disk or a memory card having the above function. Accordingly, the cost is high. In other words, the portable disk or the memory card without the multimedia functionality has insufficient function will be eventually replaced and rendered useless.

Therefore, how to resolve the above defect has become the target of the manufacturers in the field.

### SUMMARY OF INVENTION

Accordingly, in the view of the foregoing, the present inventor makes a detailed study of related art to evaluate and consider, and uses years of accumulated experience in this field, and through several experiments, to create a new adaptor having video/audio player functionality. The present invention provides an innovated cost effective adaptor having video/audio player functionality.

According to an aspect of the present invention, the adaptor has a USB port for connecting to the memory storage device without video/audio functionality. The adaptor is capable of playing the video/audio data stored within the memory storage device via the video/audio device connected to the adaptor. Thus the user can enjoy the video/audio available memory storage device, and therefore do not require a general video/audio player and thus the cost can be reduced.

According to another aspect of the present invention, the adaptor is compatible with a variety of memory storage devices with various specifications.

According to another aspect of the present invention, a microphone can be connected to the adaptor to convert the received sound into sound data and stored into the memory storage device.

### BRIEF DESCRIPTION OF DRAWINGS

For a more complete understanding of the present invention, reference will now be made to the following detailed description of preferred embodiments taken in conjunction with the following accompanying drawings.

FIG. 1 is a view showing a block diagram of an adaptor according to an embodiment of the present invention.

FIG. 2 illustrates an operation flowchart (I) of an adaptor according to an embodiment of the present invention.

FIG. 3 illustrates an operation flowchart (II) of an adaptor according to an embodiment of the present invention.

FIG. 4 is a view showing a block diagram of an adaptor according to another embodiment of the present invention.

### DETAILED DESCRIPTION

Reference will be made in detail to the preferred embodiments of the invention, examples of which are illustrated in the accompanying drawings. Wherever possible, the same reference numbers are used in the drawings and the description to refer to the same or like parts.

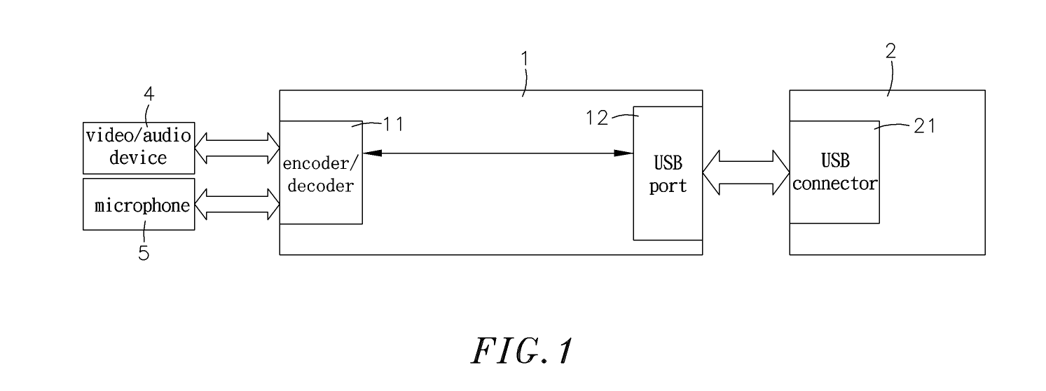

Referring to FIG. 1, is a view showing a block diagram of an adaptor according to an embodiment of the present invention. As shown, the adaptor 1 having video/audio player functionality comprises an encoder/decoder device 11 and a USB port 12.

The encoder/decoder device 11 is connected to a video/audio device 4 or a microphone 5. The encoder/decoder device 11 is capable of encoding/decoding a video/audio signal or data thereof.

The USB port 12 is connected to a USB connector 21 of the data storage device 2 and the encoder/decoder device 11.

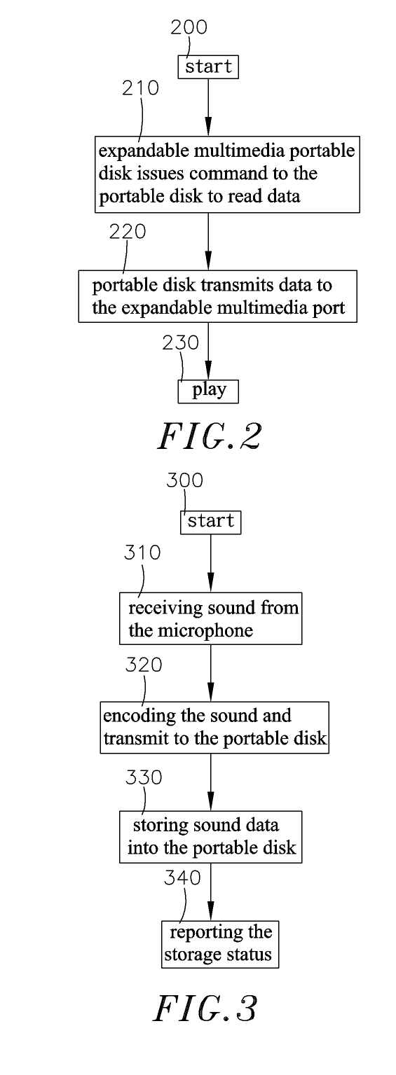

Referring to FIGS. 1 and 2, an operation procedure of the adaptor of the present invention is described. The USB port 12 of the adaptor 1 is connected to the USB connector 21 of the data storage device 2. The adaptor 1 is capable of saving/retrieving data stored in the data storage device 2 via USB port 12. When playing the video/audio data stored within the data storage device 2 via adaptor 1, the operation procedure is as follows: in step (200), the procedure starts;in step (210), the adaptor 1 commands to the data storage device 2 to read the video/audio data; in step (220), the data storage device 2 transmits the stored video/audio data via the USB connector 21 to the encoder/decoder device 11 of the adaptor 1; and in step (230), the encoder/decoder device 11 decodes the video/audio data and the connected video/audio device 4 plays the decoded data.

Referring to FIGS. 1 and 3, the operation procedure recording the sound by the adaptor 1 and storing the recorded sound into the data storage device 2 is described as follows: in step (300), the procedure starts; in step (310), the adaptor 1 receives the sound from the microphone 5 connected to the encoder/decoder device 11; in step (320), the encode/decoder device 11 transmits the encoded sound data to the data storage device 2 via USB port 12; in step (330), the data storage device 2 stores the sound data; and in step (340), the data storage device 2 reports the storage status to the adaptor 1.

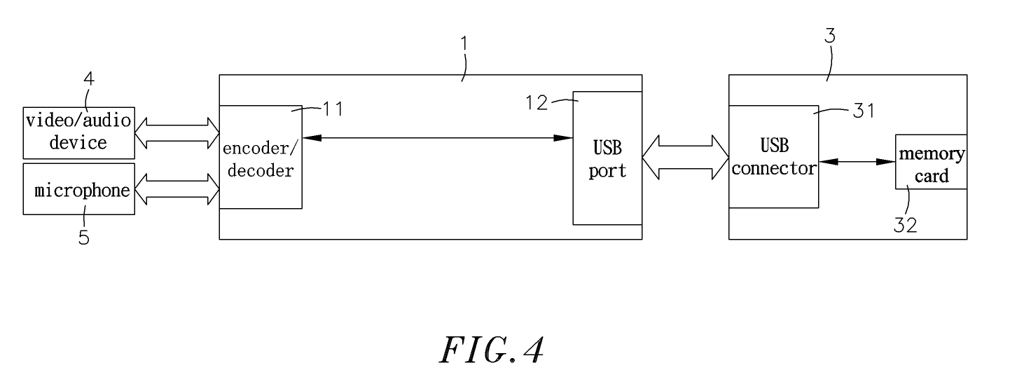

Now refer to FIG. 4, a block diagram of an adaptor according to another embodiment of the present invention is shown. As shown, the USB port 12 of the adaptor 1 can also be connected to the USB connector 31 of the card reader 3. The video/audio data stored within the memory card 32 in the card reader 3 can be played by the video/audio device 4 via adaptor 1, and the sound data received by the adaptor 1 can be stored into the memory card 32.

Furthermore, the video/audio device 4 of the present invention can be a monitor, a speaker or an earphone. The USB port 12 can be a USB port or an IEEE1394 port.

The adaptor 1 having video/audio player functionality of the present invention has at least the following advantages.

The adaptor 1 has the USB port 12, for connecting to the data storage device 2 without player functionality, is capable of playing the video/audio data stored within the data storage device 2 playing via video/audio device 4, thus the user enjoy the multimedia and need purchase a general video/audio player, and therefore the cost can be reduced.

The encoder/decoder device 11 of the adaptor 1 converts the sound received by the microphone 5 into the sound data and stores into the data storage device 2 via USB port 12.

The adaptor 1 suitable for connecting with the data storage device 2 suitable for receiving a variety of memory cards having various specifications.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and nonlimiting sense.

1. An adaptor, having video/audio player functionality, comprising:
a data storage device, without video/audio player functionality,
an encoder/decoder device, for encoding/decoding said video/audio data, said encoder/decoder device is connected to an USB port adapted for connecting to said data storage device, wherein said encoder/decoder device decodes said video/audio data stored in said data storage device so that the decoded video/audio data can be played via video/audio device connected to said encoder/decoder device via said USB port.

2. The adaptor according claim 1, wherein said encoder/decoder device is further connected to a microphone.

3. The adaptor according claim 1, wherein said video/audio device is a monitor.

4. The adaptor according claim 1, wherein said video/audio device is an earphone.

5. The adaptor according claim 1, wherein said video/audio device is a speaker.

6. The adaptor according claim 1, wherein said USB port can be a USB port.

7. The adaptor according claim 1, wherein said USB port is an IEEE1394 port.

8. The adaptor according claim 1, wherein said data storage device is a portable disk.

9. The adaptor according claim 1, wherein said data storage device is a memory card.

10. The adaptor according claim 1, wherein said data storage device is a hard disk.
